(19) United States
(12) Patent Application Publication
(10) Pub. No.: US 2003/0026639 A1
(43) Pub. Date: Feb. 6, 2003

(54) Sliding and self-adjusting apparatus for supporting computer operator wrists

(76) Inventor: Armando Barreiro JR., Albuquerque, NM (US)

Correspondence Address: FRANK L. KUBLER, 13261 S.W. 54th Court, Miramar, FL, 33027, US

(21) Appl. No.: 09/920,884

(22) Filed: Aug. 2, 2001

(51) Int. Cl. B41J 5/10; G06F 1/16

(52) U.S. Cl. 400/498; 361/680; 248/918; 248/118.3

(57) ABSTRACT

A computer data input mechanism includes a computer input data device such as a keyboard or mouse; and an operator wrist support apparatus having a support body formed of two support sacks, each support sack having a connection edge and being interconnected with the connection edge of the other sack, the support sacks having upper surfaces together defining a composite wrist support surface and tapering downwardly toward the connection edges to form a wrist receiving valley defining a carpel tunnel relief channel to reduce pressure on the carpel tunnel area of a user wrist resting on the upper support surface.

### BACKGROUND OF THE INVENTION

1. Field of the Invention

The present invention relates generally to the field of devices for supporting the wrist of a computer user while the user hand operates a keyboard, a trackball or a mouse. More specifically, the present invention relates to an apparatus including a support body formed of two support sacks containing deformable cushion material, each support sack having a connection edge and being interconnected with the connection edge of the other sack. The two interconnected support sacks have upper surfaces together defining a composite upper surface, and taper toward each other to define a wrist contact area in the form of a wrist receiving valley at the abutting connection edges defining a carpel tunnel relief channel. The relief channel extends below the wrist contact area of the wrist receiving valley to reduce or eliminate pressure on the carpel tunnel area of a user wrist. Each support sack preferably is configured as a tetrahedron having a substantially triangular sack lower face and three sloped and substantially triangular sack upper faces converging to an apex and forming a three sided pyramid. The connection edge of each sack is one of the substantially rectilinear perimeter edges of the sack lower face, this connection edge of each sack being positioned to be mutually parallel with, abutting and joined to the opposing sack connection edge, preferably by sewing. A wrist securing strap preferably extends from an upper face of one support sack to a corresponding upper face of the other support sack, both strap ends preferably being secured to the respective sack upper faces with hook and loop fastener patches.

2. Description of the Prior Art

There have in recent years been a number of devices for supporting and resting the wrist or hand of a computer operator while the hand inputs data into the computer by means of a keyboard or mouse. These devices have generally offered only a limited and often inadequate range of free hand movement to perform the input tasks. The necessary hand movement is therefore often achieved by lifting the wrist, bending the wrist frequently and in many directions, and by sliding the wrist over a device surface, causing discomfort and fatigue. These devices have also often been complex and costly to manufacture.

One prior device is that of Benaway, U.S. Pat. No. 5,040,757, issued on Aug. 20, 1991, which discloses a wrist support for use with an office machine keyboard. Benaway includes a support member having a stepped upper portion for placing underneath the forward edge of the keyboard. In this way the keyboard can be tilted upward to any of several positions defined by the various step elevations. The wrist is rested on a surface at the top of the stepped portion while the fingers type data into the computer. A problem with Benaway is that the user must continually bend his or her wrists to gain access to the entire keyboard from end to end. Another problem is that the user must slide and rotate their wrist against the non-rotating support surface for access to various keys. Both of these actions abrade the wrist and tire the user because the user must overcome friction resistance. Another problem is that the keyboard elevating capabilities would be of little use where the data input means is a mouse and mouse pad rather than a keyboard.

Moore, U.S. Pat. No. 5,203,845, issued on Apr. 20, 1993, reveals a computer mouse support. Moore includes a working surface on which a computer mouse is moved to direct a cursor on a computer screen. Mouse retaining side walls extend along the periphery of the working surface, and a wrist/palm support is provided at the forward end in the form of a sloped elevation. A problem with Moore is that the user must continually bend his or her wrists in various directions to slide the mouse. Another problem with Moore is that the support surface of the wrist/palm support does not move with the wrist, so that the surface resists movement and abrades the skin.

Latino, et al., U.S. Pat. No. 4,545,554, issued on Oct. 8, 1985, teaches a wrist support for use with an office machine having a keyboard. The Latino support includes a flat-topped bar member which fits horizontally against the front of a keyboard to support the user's arms. The height of the bar is adjustable by turning a knob at each end of the bar. Each knob is mounted to the lower end of a threaded vertical shaft extending into a vertical threaded port in the bottom of the bar. A plate extends horizontally from the bar underneath the keyboard. The elongate appendage rest of Dietrict, U.S. Pat. No. 4,973,176, issued on Nov. 27, 1990, is structurally similar to Latino. The problems of Moore are again presented for both.

Springer, U.S. Pat. No. 4,621,781, issued on Nov. 11, 1986, discloses an ergonomic forearm rest for use with keyboards. Springer includes a cushioned elongate plate pivotally secured to the forward edge of a work surface supporting a keyboard. The plate supports the arms or wrists of a keyboard operator. A problem with Springer is that the operator must bend and slide their wrists over the cushion surface and move their wrists along the keyboard for access to all keys. Berke, et al., U.S. Pat. No. 4,481,556, issued on Nov. 6, 1984, and Fowler, et al., U.S. Pat. No. 4,688,862, issued on Aug. 28, 1987, both teach an elongate wrist support member similar to Springer, secured along the forward edge of a keyboard. The problems of Springer are again presented.

Bricker, U.S. Pat. No. 4,313,585, issued Feb. 2, 1982, teaches a rolling support platform device for writing, drawing and the like. Bricker includes a metal or plastic platform member having three or more socket shaped, partial knock-outs and a ball bearing in each partial knock-out. The user rests their hand on the platform and moves their hand over the working surface as the bearings roll and carry the hand weight. A problem with Bricker is that the user can rock his or her wrist from side to side only by rolling the wrist over the upper surface of the platform, causing skin irritation and muscle fatigue. A device similar to Bricker is one known commercially as the MOUSE SHADOW™, which is produced by Shadow Tech International, Inc. of Lawton, Okla. The MOUSE SHADOW™ is essentially a thick, triangular plate having a lower face with a ball rotatably mounted in a recess at each corner and an upper face with a channel-shaped recess for retaining the user wrist. The problems of Bricker are again presented.

Zapp, U.S. Pat. No. 4,083,068, issued on Mar. 28, 1978, and U.S. Pat. No. 4,201,489, issued on May 6, 1980, reveal a keyboard actuable with the aid of the fingers of at least one hand. The Zapp devices each include a keyboard with a forward edge and a horizontal wrist supporting disk rotatably mounted at each lateral end over the forward edge. A problem with Zapp is that no provision is made for moving the hands laterally along the keyboard without lifting or sliding the wrists. The rotational support is provided at only the two disk locations. Another problem is that Zapp must replace rather than supplement an existing keyboard.

Zwar, et al., U.S. Pat. No. 5,056,743, issued on Oct. 15, 1991, discloses an arm support system. A hand board is provided with a pair of hand pads which slide on the top surface of the hand board. A problem with Zwar is that the board does not provide sufficient wrist elevation for easy reach across a keyboard. Yet if the Zwar board were elevated above the level of the keys, no pivoting function is provided to aid the hands in reaching the keys, and continual wrist bending is necessary.

It is thus an object of the present invention to provide an apparatus for supporting the wrist of a computer operator while the hand operates a keyboard, trackball or mouse for preventing fatigue of the wrist.

It is another object of the present invention to provide such an apparatus which permits a full range of movement of the wrist and hand, including rotating and sliding relative to the keyboard, trackball or mouse, while providing continuous wrist support.

It is still another object of the present invention to provide such an apparatus which automatically anchors itself against unwanted sliding when not in use and which relaxes the wrist during use.

It is finally an object of the present invention to provide such an apparatus which is small and compact for easy storage and transport, and which can be manufactured from natural materials at a very low price to be available to all computer users.

### SUMMARY OF THE INVENTION

The present invention accomplishes the above-stated objectives, as well as others, as may be determined by a fair reading and interpretation of the entire specification.

A computer data input mechanism is provided, including a computer input data device; and an operator wrist support apparatus having a support body formed of two support sacks, each support sack having a connection edge and being interconnected with the connection edge of the other sack, the support sacks having upper surfaces together defining a composite wrist support surface and tapering downwardly toward the connection edges to form a wrist receiving valley defining a carpel tunnel relief channel to reduce pressure on the carpel tunnel area of a user wrist resting on the upper support surface.

Each support sack preferably is configured substantially as a tetrahedron comprising a substantially triangular sack lower face with three substantially rectilinear perimeter edges and having three sloped and substantially triangular sack upper faces converging to an apex and forming a three sided pyramid, and the connection edge of each support sack preferably is one of the substantially rectilinear perimeter edges of the sack lower face and is positioned to be mutually parallel with, abutting and joined to the opposing the sack lower perimeter edge. The connection edges preferably are interconnected with sewn stitches. The computer data input mechanism preferably additionally includes a wrist securing strap having two strap ends and extending from an upper face of one support sack to a corresponding upper face of the other support sack, both strap ends preferably being removably secured to the respective the sack upper faces.

Each support sack preferably contains deformable cushion material. Each support sack preferably has a cushion material passing slit which is releasibly closed with releasible slit fasteners. The cushion material passing slit in each support sack preferably is located immediately adjacent to the corresponding strap end. The deformable cushion material within each support sack preferably includes a quantity of buckwheat hulls.

A wrist support apparatus is further provided, including a support body formed of two support sacks, each support sack having a connection edge and being interconnected with the connection edge of the other sack, the support sacks having upper surfaces together defining a composite wrist support surface and tapering downwardly toward the connection edges to form a wrist receiving valley defining a carpel tunnel relief channel to reduce pressure on the carpel tunnel area of a user wrist resting on the upper support surface. Each support sack preferably is configured substantially as a tetrahedron including a substantially triangular sack lower face having three substantially rectilinear perimeter edges and including three sloped and substantially triangular sack upper faces converging to an apex and forming a three sided pyramid, and the connection edge of each support sack is one of the substantially rectilinear perimeter edges of the sack lower face and is positioned to be mutually parallel with, abutting and joined to the opposing the sack lower perimeter edge. The connection edges preferably are interconnected with sewn stitches.

The wrist support apparatus preferably additionally includes a wrist securing strap having two strap ends and extending from an upper face of one support sack to a corresponding upper face of the other support sack, both strap ends preferably being removably secured to the respective sack upper faces.

Once again, each support sack preferably contains deformable cushion material. Each support sack preferably has a cushion material passing slit which is releasibly closed with releasible slit fasteners. The cushion material passing slit in each support sack preferably is located immediately adjacent to the corresponding strap end. The deformable cushion material within each support sack preferably includes a quantity of buckwheat hulls.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a front view of the wrist support apparatus having the preferred wrist securing strap.

FIG. 2 is a side view of the apparatus of FIG. 1 in front of a data input device in the form of a computer keyboard.

FIG. 3 is a rear view of the wrist support apparatus of FIG. 1, showing the removably secured strap ends and the cushion material passing slits. One slit is shown open, exposing some cushion material in the form of hulls, some of which is scattered on the support surface.

FIG. 4 is a rear view of the wrist support apparatus shown with a cross-section of a user/operator wrist resting in the apparatus wrist receiving valley, illustrating how the apparatus deforms during use and how the carpel tunnel relief channel leaves the carpel tunnel area of the wrist free of pressure.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### Preferred Embodiments

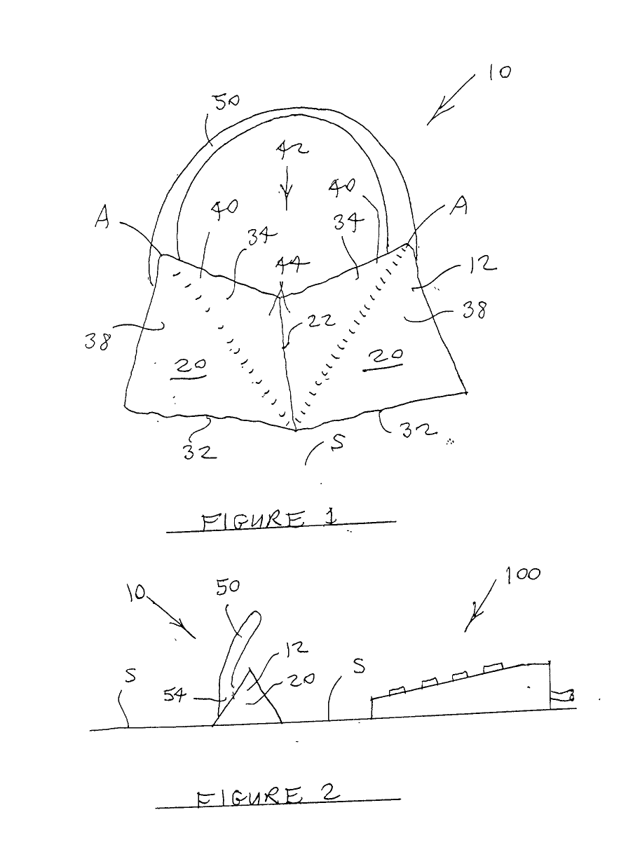

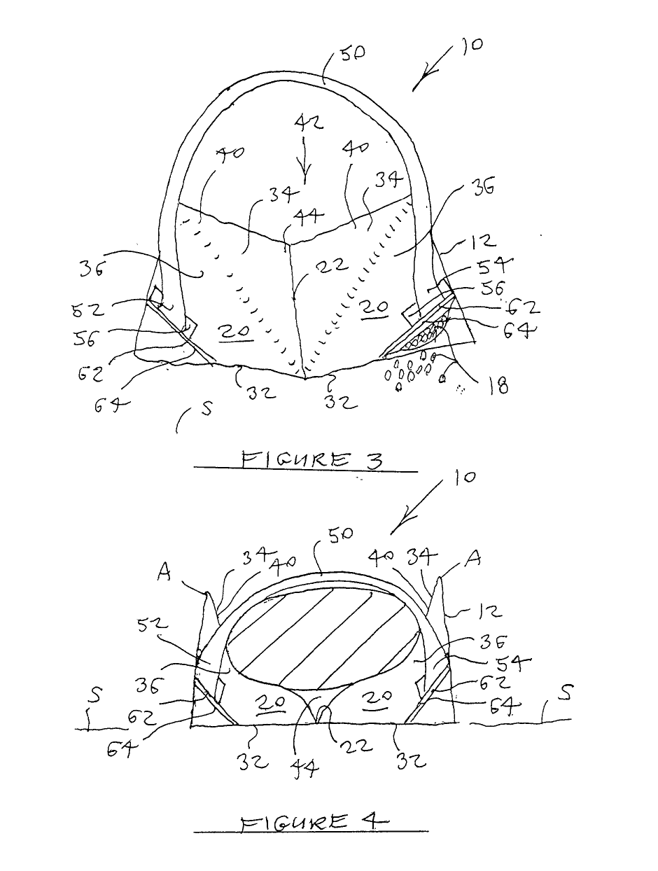

Referring to FIGS. 1-4, an apparatus 10 is disclosed for supporting the wrist of a computer operator as the operator hand inputs data into a computer data input device 100 such as a keyboard or mouse. Apparatus 10 includes a support body 12 formed of two support sacks 20 containing deformable cushion material 18, each support sack 20 having a connection edge 22 and being interconnected with the connection edge 22 of the other sack 20. The two interconnected support sacks 20 have upper surfaces together defining a composite upper surface 40, and taper toward each other to define a wrist contact area in the form of a wrist receiving valley 42 at the abutting connection edges 22 defining a carpel tunnel relief channel 44. Relief channel 44 extends below the wrist contact area of the wrist receiving valley 42 to reduce or eliminate pressure on the carpel tunnel area of a user wrist. Each support sack 20 preferably is configured as a tetrahedron having a substantially triangular sack lower face 32 and three sloped and substantially triangular sack upper faces 34, 36 and 38 converging to an apex A and forming a three sided pyramid. The two sack lower faces 32 together define a support surface contact area 24. The connection edge 22 of each sack 20 is one of the substantially rectilinear perimeter edges of the sack lower face 32, this lower connection edge 22 of each sack being positioned to be mutually parallel with, abutting and joined to the opposing sack connection edge 22, preferably by sewing. A wrist securing strap 50 preferably extends from an upper face 36 of one support sack 20 to a corresponding upper face 36 of the other support sack 20, both strap ends 52 and 54 preferably being secured to the respective sack upper faces 36 with hook and loop fastener patches 56. The user simply detaches one strap end 54 and fits a wrist into the wrist receiving valley 42 between the two sack apexes A, and then reconnects the detached strap end 54. See FIGS. 3 and 4. Each support sack 20 has a cushion material passing slit 62 which is releasibly closed with releasible fastener means such as hook and loop fastener strips 64. The cushion material passing slits 62 preferably are located immediately adjacent to the strap ends 54 and 56.

The deformable cushion material 18 within each support sack 20 preferably is loose buckwheat hulls, which provide a light, natural, well cushioned support much like that of a feather pillow, and yet are an inexpensive by-product of wheat harvesting. The sack outer skin material preferably is a suitable cloth, such as one hundred percent breathable cotton.

The wrist receiving valley 42 rises to the sack apexes A on either side of the user wrist to prevent the wrist from sliding off apparatus 10. The support surface contact area 24 is substantially planar and is preferably formed of a low friction material. The planar shape of contact area 24 assures that wrist and apparatus 10 weight are widely distributed so that friction with the support surface S is minimized at any given point.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A computer data input means, comprising:
a computer input data device;
and an operator wrist support apparatus comprising a support body formed of two support sacks, each said support sack having a connection edge and being interconnected with the connection edge of the other sack, said support sacks having upper surfaces together defining a composite wrist support surface and tapering downwardly toward the connection edges to form a wrist receiving valley defining a carpel tunnel relief channel to reduce pressure on the carpel tunnel area of a user wrist resting on said upper support surface.

2. The computer data input means of claim 1, wherein each said support sack is configured substantially as a tetrahedron comprising a substantially triangular sack lower face having three substantially rectilinear perimeter edges and comprising three sloped and substantially triangular sack upper faces converging to an apex and forming a three sided pyramid, and wherein the connection edge of each said support sack is one of said substantially rectilinear perimeter edges of said sack lower face and is positioned to be mutually parallel with, abutting and joined to the opposing said sack lower perimeter edge.

3. The computer data input means of claim 1, wherein said connection edges are interconnected with sewn stitches.

4. The computer data input means of claim 2, additionally comprising a wrist securing strap having two strap ends and extending from an upper face of one said support sack to a corresponding upper face of the other said support sack, both said strap ends being removably secured to the respective said sack upper faces.

5. The computer data input means of claim 1, wherein each said support sack contains deformable cushion material.

6. The computer data input means of claim 5, wherein said deformable cushion material within each said support sack comprises a plurality of buckwheat hulls.

7. The computer data input means of claim 1, wherein each said support sack has a cushion material passing slit which is releasibly closed with releasible slit fastener means.

8. The computer data input means of claim 7, wherein the cushion material passing slit in each said support sack is located immediately adjacent to the corresponding said strap end.

9. A wrist support apparatus, comprising:
a support body formed of two support sacks, each said support sack having a connection edge and being interconnected with the connection edge of the other sack, said support sacks having upper surfaces together defining a composite wrist support surface and tapering downwardly toward the connection edges to form a wrist receiving valley defining a carpel tunnel relief channel to reduce pressure on the carpel tunnel area of a user wrist resting on said upper support surface.

10. The wrist support apparatus of claim 9, wherein each said support sack is configured substantially as a tetrahedron comprising a substantially triangular sack lower face having three substantially rectilinear perimeter edges and comprising three sloped and substantially triangular sack upper faces converging to an apex and forming a three sided pyramid, and wherein the connection edge of each said support sack is one of said substantially rectilinear perimeter edges of said sack lower face and is positioned to be mutually parallel with, abutting and joined to the opposing said sack lower perimeter edge.

11. The wrist support apparatus of claim 9, wherein said connection edges are interconnected with sewn stitches.

12. The wrist support apparatus of claim 10, additionally comprising a wrist securing strap having two strap ends and extending from an upper face of one said support sack to a corresponding upper face of the other said support sack, both said strap ends being removably secured to the respective said sack upper faces.

13. The wrist support apparatus of claim 9, wherein each said support sack contains deformable cushion material.

14. The wrist support apparatus of claim 13, wherein said deformable cushion material within each said support sack comprises a plurality of buckwheat hulls.

15. The wrist support apparatus of claim 13, wherein each said support sack has a cushion material passing slit which is releasibly closed with releasible slit fastener means.

16. The wrist support apparatus of claim 15, wherein the cushion material passing slit in each said support sack is located immediately adjacent to the corresponding said strap end.
